(19) United States
(12) Patent Application Publication
(10) Pub. No.: US 2006/0222792 A1
(43) Pub. Date: Oct. 5, 2006

(54) Temozolomide storage system

(75) Inventors: Oleg Braverman, Beer-Sheva (IL); Rimma Feinshtein, Beer-Sheva (IL); Alex Weisman, Kiriat Ekron (IL); Joseph Kaspi, Givatayim (IL)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: CHEMAGIS LTD., Bnei Brak (IL)

(21) Appl. No.: 11/409,345

(22) Filed: Apr. 21, 2006

(51) Int. Cl. B32B 27/32

(52) U.S. Cl. 428/35.2

(57) ABSTRACT

The present invention provides an improved storage system for temozolomide, which preferably includes one or more bags (e.g., 3 bags, optionally containing a desiccant interposed between two of the bags). The storage system of the present invention can maintain temozolomide as a white, stable, and dry material after long periods of storage. The present invention also provides methods of producing and storing temozolomide as a stable, white solid.

### BACKGROUND OF THE INVENTION

Temozolomide is the international non-proprietary name used to identify 8-carbamoyl-3-methyl-imidazo[5,1-d]-1,2,3,5-tetrazin-4(3H)-one (I), which has the following molecular structure:

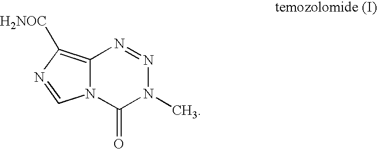

Temozolomide is an antitumor agent indicated for treating patients with malignant glioma such as cancer, breast cancer, refractory anaplastic astrocytoma, i.e., patients at first relapse who have experienced disease progression in malignant glioma, glioblastoma multiform and anaplastic astrocytoma, on a drug regimen containing a nitrosourea and procarbazine.

Temozolomide preparations are sold on the US market as hard capsules containing 5 mg, 20 mg, 100 mg or 250 mg temozolomide (marketed as Temodar® by Schering Corporation, Kenilworth, N.J., USA). In other markets it is sold as Temodal®.

A process for preparing temozolomide is described in US 2002/0095036. According to the teaching of Example 1 of US 2002/0095036, temozolomide is obtained as a white precipitate. However, the Temodar® drug leaflet and the Physician Desk Reference 60^{th} Ed. (2006) state that the material is “a white to light tan/light pink powder.” The light tan/pink color is indicative of degradation.

In view of the apparent tendency of temozolomide to degrade, as evidenced by the change in color, there exists a need for products and methods, which improve the stability or shelf life of temozolomide. The present invention provides such products and methods.

### BRIEF SUMMARY OF THE INVENTION

The present invention provides a storage system for stabilizing temozolomide. The storage system of the present invention preferably comprises at least one sealed polymeric bag, (e.g., a transparent or opaque polyethylene bag) or a combination of such bags, which, if desired, may be sealed inside of a laminated aluminum bag. Optionally, a moisture absorber (or desiccant), e.g., silica gel, may be included between one or more of such bags. The polymeric bag can be any commercial bag, which is suitable for storing purposes. Suitable bags can include, for example, polyethylene bags (either low density or high density polyethylene), polypropylene bags, polyester bags, nylon bags, polyvinyl chloride (PVC) bags, and the like.

The drug packaging of the present invention can prevent (e.g., inhibit or decrease the rate of) the degradation of temozolomide over long storage periods. Preferably, the storage system is capable of reducing or eliminating drug instability due to contact with oxygen and/or water, without the need to change the drug formulation or composition.

The present invention also provides a method of maintaining the white color of temozolomide, which method preferably comprises packaging temozolomide in a controlled environment having reduced humidity level, low oxygen atmosphere and/or reduced light level relative to the external environment.

Exemplary packaging, which can be used in the storage system of the present invention, can include, e.g., packaging type 1, packaging type 2 and/or packaging type 3. When packaging type 1 is used, the temozolomide is preferably contained (e.g., packed or packaged) in a sealed transparent polymeric bag (e.g., a sealed polyethylene bag). When packaging type 2 is used, the temozolomide is preferably contained (e.g., packed or packaged) in a sealed transparent polymeric bag (e.g., a sealed polyethylene bag), which is inserted into another opaque (e.g., black) polymeric bag (e.g., a black polyethylene bag), which is then sealed effectively to prevent penetration of humidity, oxygen and/or light. When packaging type 3 is used, the temozolomide is preferably contained (e.g., packaged or packed) in a sealed transparent polymeric bag (e.g., a sealed polyethylene bag), which is inserted in an opaque (e.g., black) polymeric bag (e.g., a black polyethylene bag), which is then sealed and, in turn, put inside a sealed laminated aluminum bag, which is then sealed. For packaging type 2 and packaging type 3, a desiccant can be interposed (e.g., dispersed) between the two plastic layers (e.g., between the transparent and opaque polymeric bags).

The present invention further provides a method of producing temozolomide in the form of a white solid, which method comprises producing temozolomide in an inert atmosphere, e.g., in an atmosphere of nitrogen, argon or a combination thereof. The resulting product can be stabilized from degradation by storing the product in the storage system of the present invention.

### BRIEF DESCRIPTION OF THE DRAWING

FIG. 1 depicts the absorbance measurements of temozolomide samples using a UV spectrophotometer in the range of 350-560 nm.

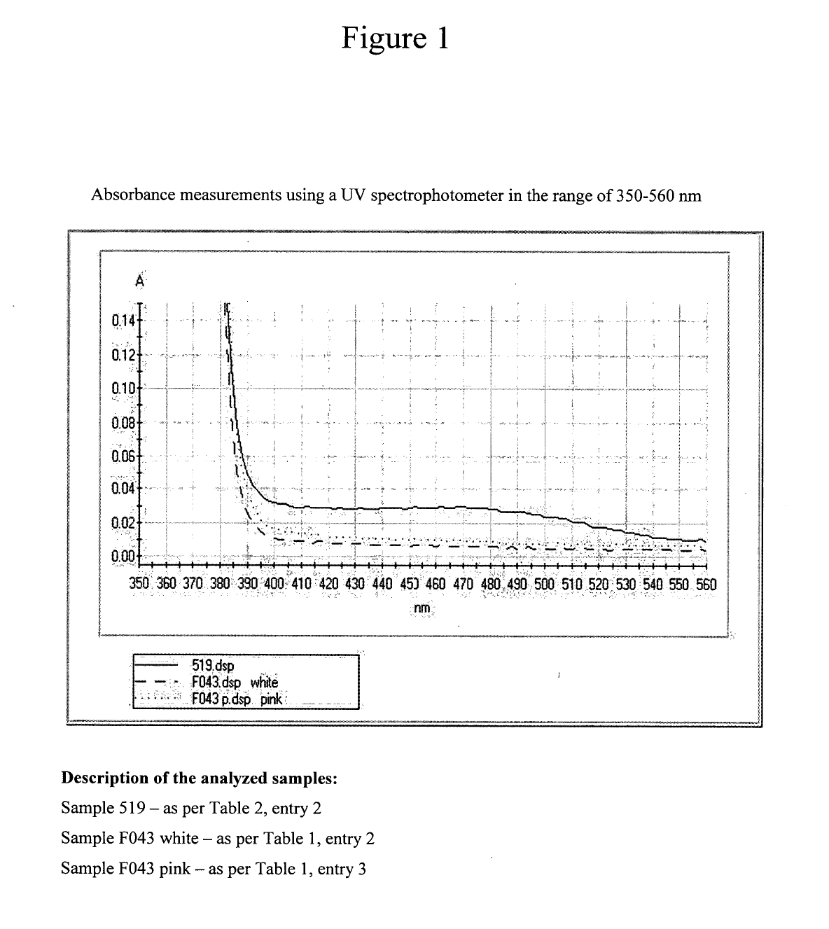

### DETAILED DESCRIPTION OF THE INVENTION

The applicants of the present invention have surprisingly discovered that storing temozolomide in a controlled environment can stabilize the temozolomide and maintain the white color of temozolomide over long storage periods. Without wishing to be bound by any particular theory, it is believed that the apparent instability problems associated with temozolomide can be overcome by storing temozolomide in an environment having reduced humidity levels, and/or low atmospheric oxygen levels and/or low light levels (e.g., in the absence of light).

The storage system of the present invention preferably includes a container with temozolomide (e.g., substantially pure temozolomide) contained therein as a white solid, wherein the container is preferably capable of providing an internal environment having a substantially lower humidity level, a substantially lower oxygen level, a substantially lower light level, or a combination thereof, relative to the external environment. The storage system of the present invention is preferably capable of maintaining the temozolomide as a white to off-white solid for at least about 1 month under normal storage conditions (e.g., under normal external atmospheric conditions of light, temperature, humidity, oxygen levels and the like). The storage system of the present invention is more preferably capable of maintaining the temozolomide as a white to off-white solid for at least about 2 months under normal storage conditions, and most preferably for at least about 6 months under normal storage conditions. In a particularly preferred embodiment, the storage system of the present invention is capable of maintaining temozolomide, e.g., dry temozolomide produced according to Example 1, as a white solid for at least about one month, at least about two months, or even at least about 6 months at 25° C. or even at 40° C.

The container, which can be used in the storage system of the present invention, preferably includes at least one sealed polymeric bag. Suitable polymeric bags can include one or more commercial bags suitable for storing purposes, e.g., polyethylene bags (e.g., low density polyethylene bags and high density polyethylene bags), polypropylene bags, polyester bags, nylon bags, polyvinyl chloride (PVC) bags, and the like. In one embodiment, the temozolomide is contained within a sealed transparent polymeric bag, which is preferably a transparent polyethylene bag, and more preferably a low density polyethylene bag. In another embodiment, the temozolomide is contained within a transparent polymeric bag, and the transparent polymeric bag is contained within a sealed opaque (e.g., black) polymeric bag, which is preferably a black polyethylene bag, and more preferably a black high density polyethylene bag. In yet another embodiment, the temozolomide is contained within a sealed transparent polymeric bag, which is contained within a sealed opaque (e.g., black) polymeric bag, and the opaque polymeric is contained within a sealed laminated aluminum bag. If desired, a desiccant can be interposed (e.g., dispersed or interspersed) between the transparent and opaque polymeric bags when such bags are used in the storage system of the present invention. Alternatively, or additionally, if desired, an inert gas atmosphere (e.g., nitrogen, argon, or a mixture thereof) can be introduced into one or more bags. For instance, the transparent polymeric bag, the opaque polymeric bag, and/or the laminated aluminum bag described herein can be packed and sealed in a nitrogen atmosphere to introduce a nitrogen atmosphere in some or all of the bags.

In a particularly preferred embodiment, the storage system includes a sealed laminated aluminum bag, an opaque (preferably black), high density polyethylene bag contained within the sealed aluminum bag, a sealed transparent low density polyethylene bag contained within the sealed opaque polyethylene bag, temozolomide contained within the transparent polyethylene bag, and, optionally, a desiccant interposed between the transparent and opaque polyethylene bags.

Suitable desiccants can include, e.g., aluminum oxide, calcium chloride, Drierite (CaSO₄), molecular sieves (e.g., activated molecular sieves), silica gel, and the like, and combinations thereof. A preferred desiccant is silica gel.

The present invention additionally provides a method for stabilizing temozolomide (or maintaining temozolomide as a white solid) for long storage periods (e.g., at least about 1 month, at least about 2 months, at least about 6 months, or even longer), which method includes packaging temozolomide as a white solid in the storage system of the present invention.

The present invention further provides a process for producing temozolomide as a white solid, which process includes synthesizing temozolomide in an inert atmosphere. The temozolomide production process can include any suitable synthesis method, including synthesis methods known in the art, which produces temozolomide as a white solid and can be performed in an inert atmosphere. Preferably, the process of the present invention includes hydrolyzing 8-cyano-3-methyl-[3H]-imidazo[5,1-d]-tetrazin-4-one in the presence of an acid to produce temozolomide as an acid addition salt, and converting the acid addition salt into temozolomide free base. More preferably, the process of the present invention preferably includes hydrolyzing 8-cyano-3-methyl-[3H]-imidazo[5,1-d]-tetrazin-4-one in the presence of an acid (e.g., hydrochloric acid) to produce temozolomide as an acid addition salt (e.g., temozolomide hydrochloride), and converting the acid addition salt into temozolomide free base in an acidic medium. The process is preferably performed under a nitrogen blanket. Exemplary temozolomide syntheses, which can be performed in an inert atmosphere in accordance with the present invention are described in U.S. patent application Ser. No. 11/354,899, filed Feb. 16, 2006 (which claims priority to U.S. Provisional Patent Application No. 60/653,528, filed Feb. 17, 2005) and U.S. Provisional Patent Application No. 60/735,828, filed Nov. 14, 2005, the contents of which are incorporated by reference as if fully set forth herein. The foregoing patent applications describe improved processes for producing temozolomide in high purity and yield via hydrolysis of 8-cyano-3-methyl-[3H]-imidazo[5,1-d]-tetrazin-4-one, followed by converting the temozolomide hydrochloride obtained to temozolomide free base in acidic medium, thus avoiding the high instability of temozolomide at non acidic pH values. The resulting product can be stabilized as a white solid by storing the product in the storage system of the present invention.

As such, the present invention provides an improved drug storage/packaging system, which preferably comprises a container that includes at least one sealed polymeric bag (e.g., a transparent or opaque polyethylene bag), a sealed laminated aluminum bag and optionally a moisture absorber or desiccant such as, e.g., silica gel. As noted herein, the drug packaging optionally can include at least one sub-packaging, which optionally contains a moisture absorber or desiccant such as, e.g., silica gel. Packaging temozolomide within the storage system of the present invention can prevent the degradation of temozolomide over long storage periods, e.g., from at least about 1 month to at least about 6 months under normal storage conditions, e.g., by maintaining the temozolomide in a controlled environment having reduced humidity level, low oxygen atmosphere and/or absence of light.

In accordance with the present invention, a reduced humidity level may be achieved and/or facilitated using methods known in the art, e.g., by using a suitable desiccant, e.g., as described herein. Additionally, in accordance with the present invention, a low oxygen atmosphere may be achieved and/or facilitated using methods known in the art, e.g., by flowing (or purging or maintaining an atmosphere of) an inert gas (e.g., nitrogen) prior to the sealing of the packaging. Further in accordance with the present invention, reducing or eliminating exposure to light (e.g., to create an environment in which light is essentially absent) may be achieved and/or facilitated using methods known in the art, e.g., by sealing the product or system in opaque packaging as described herein.

Exemplary packaging for the storage system of the present invention can include packaging type 1, wherein temozolomide is packed and sealed in a transparent polyethylene bag. Exemplary packaging for the storage system of the present invention also can include packaging type 2, wherein temozolomide is packed and sealed in a transparent polyethylene bag, which is inserted into an opaque (e.g., black) polyethylene bag, which is then sealed, wherein the packaging is sealed effectively to prevent penetration of humidity and/or oxygen. Exemplary packaging for the storage system of the present invention also can include packaging type 3, wherein temozolomide is packed and sealed in a transparent polyethylene bag, which is packed in an opaque (e.g., black) polyethylene bag, which is then sealed and, in turn, packed and sealed in a laminated aluminum bag, which is then sealed. In packaging type 2 and in packaging type 3, a desiccant optionally can be interposed (e.g., dispersed) between the two polymeric bags/layers. In accordance with the present invention, each packaging, e.g., packaging type 1, type 2, and/or type 3 as described herein, can be packed under an inert atmosphere (e.g., under a nitrogen atmosphere) or in ambient air. In a preferred embodiment, the storage system of the present invention includes a type 3 packaging with a silica gel desiccant, wherein the packaging is optionally packed and sealed under a nitrogen atmosphere. An exemplary type 3 packaging is described in Example 2, which describes a type 3 packaging containing a silica gel desiccant, optionally under nitrogen atmosphere, which is effective in maintaining the temozolomide white color for long storage periods.

The following examples further illustrate the invention but, of course, should not be construed as in any way limiting its scope.

The following protocols were used in the examples.

The Humidity was checked by Karl-Fischer analysis, using a Mettler Toledo model DL55 Titrator.

Analytical measurements of the temozolomide samples were performed using an HPLC system equipped with Phenomenex Synergi™ Fusion-RP C18 column, 250×4.6 mm, and a UV detector operated on 250 nm. Analyses were performed using the following mobile phase, at flow rate of 1.0 ml/minute: Mobile phase: 90% Solution A: 0.02M potassium dihydrogen phosphate buffer (pH 3); 10% Solution B: acetonitrile.

Absorbance measurements were carried out using a UV-visible spectrophotometer model Spectronic Genesys 10 of Thermo Electron. The concentration of the measured temozolomide samples was 1 mg/ml in acetonitrile.

### EXAMPLE 1

This example illustrates an exemplary method of preparing temozolomide.

A 250 ml reaction vessel equipped with a magnetic stirrer and a reflux condenser was charged with 8-cyano-3-methyl-[3H]-imidazo-[5,1-d]-tetrazin-4-one (10 grams, 0.0568 mol) and hydrochloric acid (36.5-38%, 50 ml). The reaction vessel was purged with nitrogen blanket in order to remove oxygen. The reaction mixture was heated to 32-35° C. and stirring was maintained at this temperature for about 3 hours. A sample was withdrawn and analyzed by HPLC to verify that the high conversion was received. (If the content of the starting material 8-cyano-3-methyl-[3H]-imidazo-[5,1-d]-tetrazin-4-one is more than 2.5% by area according to HPLC, the stirring may be continued for additional one hour.)

The reaction mixture was then cooled to 20° C. and 50 ml of acetone were added drop-wise while maintaining the temperature at 20° C. Stirring was continued for 15-30 minutes. The precipitated white crystals were washed with cold acetone (20 ml) and dried at 40° C. in vacuum to obtain 11.7 grams (0.0507 mol) of temozolomide hydrochloride (89.3% yield). Purity (by HPLC): 99.6%.

### EXAMPLE 2

This example illustrates the stability of temozolomide under various storage conditions.

A white temozolomide sample (number F043) was divided into several small samples, which were packed in different drug packaging and stored for periods of 4-6 weeks at warehouse conditions, after which time the color changes were observed. The results are summarized in Table 1.

TABLE 1

| Entry | | | |
|---|---|---|---|
| No. | Packaging type | Storage period | Color |
| 1 | Type 1 at ambient air | 6 weeks | pinkish |
| 2 | Type 3 at ambient air containing a | 4 weeks | white |
| | desiccant in the inner packaging | | |
| 3 | Type 3 - the inner bag of entry 2 was | 6 weeks | pinkish |
| | left out (sealed) for two more weeks | | |
| 4 | Type 3 under nitrogen without | 4 weeks | traces of |
| | desiccant | | pink color |
| 5 | Type 3 under nitrogen containing a | 6 weeks | white |
| | desiccant in the inner packaging | | |
| 6 | Type 3 under nitrogen without | 8 weeks | pinkish |
| | desiccant in the inner packaging | | |
| 7 | Type 3 at ambient air containing a | 10 weeks | white |
| | desiccant in the inner packaging | | |

It may be seen from entry 1 and entry 6 that without proper humidity protection (e.g., the usage of a desiccant) the temozolomide drug becomes pinkish. However, as shown by entry 7, using a 3-bag packaging (e.g., packaging type 3 under ambient air with desiccant) enables maintaining the white color, for as long as 10 weeks without the need to pack the drug under nitrogen atmosphere.

### EXAMPLE 3

This example illustrates the stability of temozolomide in an exemplary storage system.

Three different samples of temozolomide were stored at warehouse conditions in a type 3 packaging. A small quantity was taken from each sample after 1, 2 and 6 months and the purity was checked by HPLC and compared to the original HPLC chromatogram of each sample (before starting the storage period). The purity of each sample was obtained as % area by the HPLC chromatogram and compared to the initial purity value (before starting the storage period). The results are summarized in Table 2.

TABLE 2

| | | | Purity, | Purity, | |
|---|---|---|---|---|---|
| | | | % by | % by | |
| | | | HPLC | HPLC | |
| | | Initial | after 1 | after 2 | Purity, % by |
| | Sample | purity, % | month of | months of | HPLC after 6 |
| Entry | number | by HPLC | storage | storage | month of storage |
| 1 | 3417 | 99.7 | 99.8 | 99.9 | 99.7 |
| 2 | 519* | 97.9 | 97.3 | 97.3 | 96.2 |
| 3 | 3034 | 99.8 | 99.7 | 99.8 | 99.8 |

*Sample number 519 is a wet material containing about 1.8% of water, according to KF test.

The foregoing results show that temozolomide can be stabilized over prolonged storage periods in type 3 packaging; however, the wet sample (no. 519), having water content of about 1.8%, appeared to decompose at a faster rate than the dry samples (nos. 3417 and 3034) having water content of less than 0.1% (according to KF test).

### EXAMPLE 4

This example illustrates the effect of humidity on temozolomide stability.

Three samples of temozolomide were stored in an open glass vessel at different relative humidity (RH) conditions for storage periods of up to 3 weeks, after which time the color changes were evaluated. The results are summarized in Table 3.

TABLE 3

| Entry | RH % | Storage time | Result of visual test |
|---|---|---|---|
| 1 | 20% | 3 weeks | White |
| 2 | 45% | 4 days | After 24 hours of storage the color |
| | | | became pinkish. |
| | | | After 4 days of storage the color became |
| | | | distinctly pink. |
| 3 | 80% | 4 days | pink color |

It may be concluded from this test that increasing the RH conditions can increase the rate of formation of the pink color.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A storage system comprising a container and temozolomide contained therein as a white solid, wherein the storage system is capable of providing an internal environment having a substantially lower humidity level, a substantially lower oxygen level, a substantially lower light level, or a combination thereof, relative to the environment outside of the storage system.

2. The storage system of claim 1, wherein the storage system is capable of maintaining the temozolomide as a white to off-white solid for at least about 1 month under normal storage conditions.

3. The storage system of claim 1, wherein the storage system is capable of maintaining the temozolomide as a white to off-white solid for at least about 2 months under normal storage conditions.

4. The storage system of claim 1, wherein the storage system is capable of maintaining the temozolomide as a white to off-white solid for at least about 6 months under normal storage conditions.

5. The storage system of claim 1, wherein the container comprises at least one sealed polymeric bag.

6. The storage system of claim 5, wherein the polymeric bag is a polyethylene bag, a polypropylene bag, a polyester bag, a nylon bag, or a polyvinyl chloride (PVC) bag.

7. The storage system of claim 5, wherein the polymeric bag is a low density polyethylene bag or a high density polyethylene bag.

8. The storage system of claim 1, wherein the container comprises a sealed transparent polymeric bag and the temozolomide is contained within the sealed transparent polymeric bag.

9. The storage system of claim 8, wherein the transparent polymeric bag is a transparent polyethylene bag.

10. The storage system of claim 9, wherein the transparent polyethylene bag is a low density polyethylene bag.

11. The storage system of claim 8, wherein the transparent polymeric bag is contained within a sealed opaque polymeric bag.

12. The storage system of claim 11, wherein the opaque polymeric bag is a black polyethylene bag.

13. The storage system of claim 11, wherein the opaque polymeric bag is a high density polyethylene bag.

14. The storage system of claim 11, wherein the opaque polymeric bag is contained within a sealed laminated aluminum bag.

15. The storage system of claim 11, further comprising a desiccant interposed between the transparent and opaque polymeric bags.

16. The storage system of claim 14, wherein a nitrogen atmosphere exists within the transparent polymeric bag, the opaque polymeric bag, the laminated aluminum bag, or a combination thereof.

17. The storage system of claim 1, comprising a sealed laminated aluminum bag, an opaque polyethylene bag contained within the aluminum bag, and a sealed transparent polyethylene bag contained within the opaque polyethylene bag, wherein the temozolomide is contained within transparent polymeric bag and a desiccant is optionally interposed between the transparent and opaque polymeric bags.

18. The storage system of claim 17, wherein the desiccant comprises aluminum oxide, calcium chloride, Drierite (CaSO₄), molecular sieve (activated), silica gel, or a combination thereof.

19. The storage system of claim 8, wherein the desiccant is silica gel.

20. A method for maintaining temozolomide as a white solid for long storage periods, the method comprising packaging temozolomide as a white solid within a controlled environment having reduced humidity level, low oxygen atmosphere, low light level, or a combination thereof, relative to the external environment.

21. A method of stabilizing temozolomide as a white solid, the method comprising containing the temozolomide as a white solid within the storage system of claim 1.

22. A process for producing temozolomide as a white solid, the process comprising synthesizing temozolomide in an inert atmosphere.

23. The process of claim 22, comprising hydrolyzing 8-cyano-3-methyl-[3H]-imidazo[5,1-d]-tetrazin-4-one in the presence of an acid to produce temozolomide as an acid addition salt, and converting the acid addition salt to temozolomide free base.

24. A method for stabilizing temozolomide, the method comprising synthesizing temozolomide under in an inert atmosphere and containing the temozolomide within the storage system of claim 1.

25. The method of claim 24, wherein the synthesis comprises hydrolyzing 8-cyano-3-methyl-[3H]-imidazo[5,1-d]-tetrazin-4-one in the presence of an acid to produce temozolomide as an acid addition salt, and converting the acid addition salt to temozolomide free base.
